(19) United States
(12) Patent Application Publication
(10) Pub. No.: US 2012/0199429 A1
(43) Pub. Date: Aug. 9, 2012

(54) HYDRAULIC SHOCK ABSORBER AND DAMPING FORCE GENERATOR

(75) Inventors: Yuki OSHIE, Gyoda City (JP); Yasunori MATSUTAKE, Gyoda City (JP); Kenichiro KANEKO, Gyoda City (JP)

(73) Assignee: Showa Corporation, Gyoda City (JP)

(21) Appl. No.: 13/363,850

(22) Filed: Feb. 1, 2012

(30) Foreign Application Priority Data
Feb. 9, 2011 (JP) 2011-025756

(51) Int. Cl. F16F 9/16

(52) U.S. Cl. 188/313

(57) ABSTRACT

A hydraulic shock absorber includes: a dividing member dividing a closed space and having a communicating passage for communicating divided spaces; a valve covering an open end of the communicating passage; a bolt penetrating through the dividing member and the valve; and a nut fastening the dividing member and the valve together with the bolt. The bolt or the nut has a head fitted with an industrial tool, and a base end arranged on a valve side beyond the head to contact with the valve and including an extending part extending outside an outer shape of the head in a radial direction, a facing part of the base end facing the valve comes into contact with the valve at a position inside an outermost end of the extending part in the radial direction, and an outer region outside a contact part does not come into contact with the valve.

### CROSS REFERENCE TO RELATED APPLICATIONS

This application is based on and claims priority under 35 USC §119 from Japanese Patent Application No. 2011-025756 filed Feb. 9, 2011.

### BACKGROUND

1. Technical Field

The present invention relates to a hydraulic shock absorber and a damping force generator.

2. Related Art

A suspension of a vehicle such as an automobile is provided with a hydraulic shock absorber using a damping force generator in order to appropriately absorb vibration transmitted from a road surface to the vehicle while moving and to improve ride quality and handling.

For example, a hydraulic shock absorber described in Japanese Patent Application Laid Open Publication No. 2002-227900 has a following configuration. That is, the hydraulic shock absorber includes: a piston valve device that is configured by a cylinder formed of an inner cylinder in which a piston slide and an outer cylinder arranged outside the inner cylinder, as a double cylinder, and a damping force generating valve and the like mounted on a piston rod inserted into the inner cylinder; and a bottom valve device that is configured by a damping force generating valve and the like and is provided at the bottom. In the piston valve device, a piston in which space is divided and an oil passage is formed, a valve stopper, a valve sheet and the like are mounted on the piston rod, and they are fixed with a nut. In the bottom valve device, a bottom piece in which space is divided and an oil passage is formed, a damping force generating valve and the like are fixed with a bolt and a nut.

For achieving cheaper hydraulic shock absorbers, the number of components may be reduced and assembly thereof may be facilitated by forming the valve device by use of a dividing member such as a piston in which space is divided and oil passage is formed, a valve for generating damping force, a bolt and a nut, and by omitting a valve stopper and a valve sheet. However, simply omitting the valve stopper and the valve sheet may result in deformation of this valve because an industrial tool for rotating and tightening the nut hits a valve for damping when the valve device is assembled.

Accordingly, in addition to simply omitting the valve stopper and the valve sheet, a flange nut may be used instead of a commonly-used nut. However, usage of the flange nut makes the valve for generating damping force difficult to deform since the diameter at which the valve starts deforming becomes larger than that in a case where the valve sheet is used, and thereby oil is difficult to smoothly flow. As a result, unstable damping force and reduction in responsiveness may be lead in the hydraulic shock absorber.

The present invention is to provide a device that achieves reduction of the number of components and easy assembly while unstable damping force and reduction in responsiveness are suppressed.

### SUMMARY

In order to achieve aforementioned object, according to an aspect of the present invention, there is provided a hydraulic shock absorber including: a dividing member that divides a closed space and in which a communicating passage for communicating divided spaces is formed; a valve that covers an open end of the communicating passage of the dividing member; a bolt that penetrates through the dividing member and the valve; and a nut that fastens the dividing member and the valve together with the bolt. The bolt or the nut has a head that is fitted with an industrial tool, and a base end that is arranged on a valve side beyond the head to come into contact with the valve and includes an extending part extending outside an outer shape of the head in a radial direction, a facing part of the base end that faces the valve comes into contact with the valve at a position inside an outermost end of the extending part in the radial direction, and an outer region outside a contact part does not come into contact with the valve.

Here, the outer region of the base end outside the contact part coming into contact with the valve is inclined with respect to a horizontal surface passing through the contact part.

Further, the outer region of the base end outside the contact part coming into contact with the valve is an inclined surface that is inclined with respect to a horizontal surface passing through the contact part, and the inclined surface is a concave-convex surface.

Furthermore, the facing part of the base end facing the valve comes into contact with an outermost end of the valve when the valve deforms from the contact part with the base end.

Still furthermore, the base end and the valve come into surface contact with each other.

From another aspect of the present invention, there is provided a hydraulic shock absorber including: a dividing member that divides a closed space and in which a communicating passage for communicating divided spaces is formed; a valve that covers an open end of the communicating passage of the dividing member; a rod that has a first columnar part that is formed into a column and that penetrates through the dividing member and the valve, and a second columnar part that is formed into a column and that has an outer diameter larger than an outer diameter of the first columnar part; and a nut that fastens the dividing member and the valve together with a male screw formed in the first columnar part of the rod. A facing part of the second columnar part of the rod that faces the valve comes into contact with the valve at a position inside an outer circumferential surface of the second columnar part, and an outer region outside a contact part does not come into contact with the valve.

From further aspect of the present invention, there is provided a damping force generator of a hydraulic shock absorber in which oil is enclosed in a closed space, the damping force generator including: a dividing member that divides the closed space and in which a communicating passage for communicating divided spaces is formed; a valve that covers an open end of the communicating passage of the dividing member; a bolt that penetrates through the dividing member and the valve; and a nut that fastens the dividing member and the valve together with the bolt. The bolt or the nut has a head that is fitted with an industrial tool, and a base end that is arranged on a valve side beyond the head to come into contact with the valve and includes an extending part extending outside an outer shape of the head in a radial direction, the base end comes into contact with the valve at a position inside an outermost end of the extending part in the radial direction, and an outer region outside a contact part does not come into contact with the valve.

From furthermore aspect of the present invention, there is provided a damping force generator of a hydraulic shock absorber in which oil is enclosed in a closed space, the damping force generator including: a dividing member that divides the closed space and in which a communicating passage for communicating divided spaces is formed; a valve that covers an open end of the communicating passage of the dividing member; a rod that has a first columnar part that is formed into a column and that penetrates through the dividing member and the valve, and a second columnar part that is formed into a column and that has an outer diameter larger than an outer diameter of the first columnar part; and a nut that fastens the dividing member and the valve together with a male screw formed in the first columnar part of the rod. A facing part of the second columnar part of the rod that faces the valve comes into contact with the valve at a position inside an outer circumferential surface of the second columnar part, and an outer region outside a contact part does not come into contact with the valve.

According to the present invention, it is possible to reduce the number of components and facilitate assembly while unstable damping force and reduction in responsiveness are suppressed.

### BRIEF DESCRIPTION OF THE DRAWINGS

An exemplary embodiment of the present invention will be described in detail based on the following figures, wherein:

FIG. 1 is a view for illustrating a schematic configuration of a hydraulic shock absorber according to the exemplary embodiment;

FIG. 2 is an exploded diagram for illustrating component parts of the first valve device;

FIG. 3 is an exploded diagram for illustrating component parts of the second valve device;

FIG. 4 is a cross sectional view of the first valve device and the second valve device;

FIG. 5 is a view for illustrating flow of oil in the hydraulic shock absorber at the compression process;

FIG. 6 is a view for illustrating flow of oil in the hydraulic shock absorber at the extension process;

FIG. 7 is a view for illustrating an appearance when the first valve device is unitized;

FIG. 8 is an enlarged cross-sectional view of the nut in the first valve device, and is a view in which a Z part in FIG. 4 is enlarged;

FIGS. 9A and 9B are views for schematically illustrating deformation of the second valve at the extension process of the hydraulic shock absorber;

FIG. 10 is a view for illustrating another configuration of the nut of the first valve device;

FIG. 11 is a view for illustrating further configuration of the nut of the first valve device;

FIG. 12 is a view for illustrating furthermore configuration of the nut of the first valve device;

FIG. 13 is a view for illustrating still furthermore configuration of the nut of the first valve device; and

FIG. 14 is a view for illustrating another configuration of the second valve device.

### DETAILED DESCRIPTION

Hereinafter, an exemplary embodiment of the present invention will be described in detail with reference to the attached drawings.

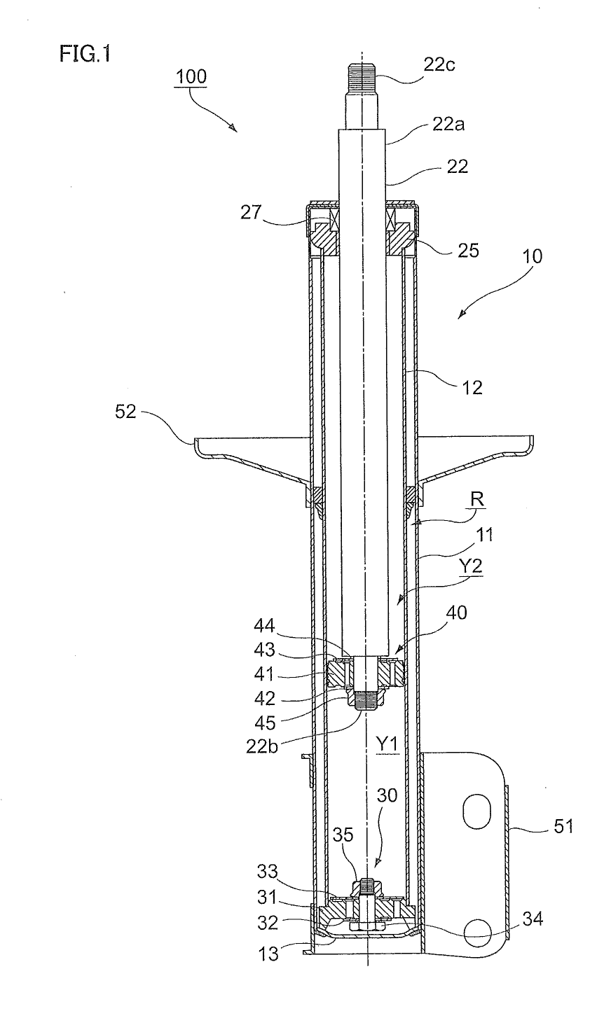

FIG. 1 is a view for illustrating a schematic configuration of a hydraulic shock absorber 100 according to the exemplary embodiment.

The hydraulic shock absorber 100 according to the exemplary embodiment is a multi-cylinder hydraulic shock absorber configuring a part of a strut-type suspension.

As shown in FIG. 1, the hydraulic shock absorber 100 is provided with a cylinder 10 including: an outer cylinder 11 that is formed into a cylinder having a thin wall thickness; an inner cylinder 12 that is contained in the outer cylinder 11 and is formed into a cylinder having a thin wall thickness; and a bottom cap 13 that covers one end of the outer cylinder 11 in a centerline direction of the cylinder (up-and-down direction in FIG. 1). Hereinafter, the centerline direction of the cylinder forming the outer cylinder 11 is simply referred to as a “centerline direction.”

The hydraulic shock absorber 100 is also provided with: a piston 41 as an example of a dividing member inserted into the inner cylinder 12 so as to be movable in the centerline direction; a piston rod 22 that extends in the centerline direction and supports the piston 41 at one end (lower end in FIG. 1) in the centerline direction; and a rod guide 25 that is arranged inside the outer cylinder 11 and that guides the piston rod 22. The piston 41 is in contact with the inner circumference of the inner cylinder 12, and divides the space in which liquid inside the inner cylinder 12 (oil in the exemplary embodiment) is enclosed into a first oil field Y1 located on one end side beyond the piston 41 in the centerline direction and a second oil field Y2 located on the other end side beyond the piston 41 in the centerline direction.

The hydraulic shock absorber 100 is provided with an oil sealing 27 that is arranged on the side opposed to the piston 41 with respect to the rod guide 25 and that prevents liquid inside the cylinder 10 from leaking and foreign matter from getting into the cylinder 10.

The hydraulic shock absorber 100 is provided with: a first valve device 30 that is arranged at one end of the inner cylinder 12 in the centerline direction; and a second valve device 40 that is arranged at one end of the piston rod 22 in the centerline direction.

Further, the hydraulic shock absorber 100 is provided with: a bracket 51 for connection to a knuckle (not shown) of a wheel to which this hydraulic shock absorber 100 is attached; an upper spring sheet (not shown) that is attached to the other end (upper end in FIG. 1) of the piston rod 22 in the centerline direction; and a lower spring sheet 52 that supports a spring (not shown) together with the upper spring sheet.

The hydraulic shock absorber 100 having such a configuration absorbs impact force while a vehicle to which the hydraulic shock absorber 100 is attached is moving.

Hereinafter, each component part is described in detail.

In the cylinder 10, the length of the outer cylinder 11 in the centerline direction is longer than the length of the inner cylinder 12, and the inner cylinder 12 is coaxially arranged with respect to the outer cylinder 11. That is, one end of the inner cylinder 12 in the centerline direction is supported by one end of the outer cylinder 11 in the centerline direction via the bottom cap 13 and a valve body 31 that is one component part configuring the first valve device 30 and will be described later. On the other hand, the other end of the inner cylinder 12 in the centerline direction is supported by the rod guide 25. By these supports, the inner cylinder 12 is coaxially arranged with respect to the outer cylinder 11 so that the gap between the outer circumference of the inner cylinder 12 and the inner circumference of the outer cylinder 11 is set constant in the centerline direction. The outer circumference of the inner cylinder 12 and the inner circumference of the outer cylinder 11 form a reservoir R. In the hydraulic shock absorber 100 according to the exemplary embodiment, the inside of the reservoir R is divided into an oil field in which oil is enclosed and a gas field in which air, inert gas and the like are enclosed. In the first valve device 30, the first oil field Y1 and the reservoir R are divided by the valve body 31 that will be described later.

By attaching the bottom cap 13 to one end of the outer cylinder 11 in the centerline direction, and by roller swaging, in the inner diameter direction, the other end of the outer cylinder 11 in the centerline direction for blocking, the inner cylinder 12 in the centerline direction is positioned through the oil seal 27, the rod guide 25, the first valve device 30 and the like.

The piston 41 is a cylindrical component having multiple oil passages formed in the centerline direction, and forms a part of the second valve device 40 that will be described later. The second valve device 40, together with the piston 41, will be described later in detail.

The piston rod 22 is a solid component, and includes a rod part 22a that is formed into a cylinder, an attachment part 22b located on one end side in the centerline direction for attaching the piston 41 or the like thereto, and an attachment part 22c located on the other end side in the centerline direction for attaching the piston rod 22 to a vehicle. Outer surfaces of tips of the attachment parts 22b and 22c are spirally grooved to form male screws, and they serve as bolts. Description of the attachment part 22b will be given later. The attachment part 22c is attached to a vehicle via a mounting rubber and the like.

Next, description will be given for the first valve device 30 and the second valve device 40.

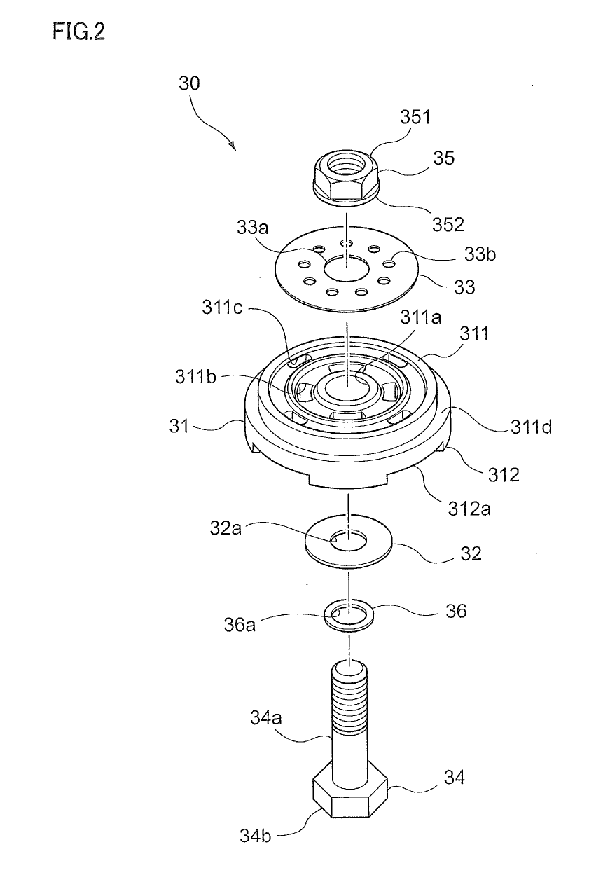

FIG. 2 is an exploded diagram for illustrating component parts of the first valve device 30.

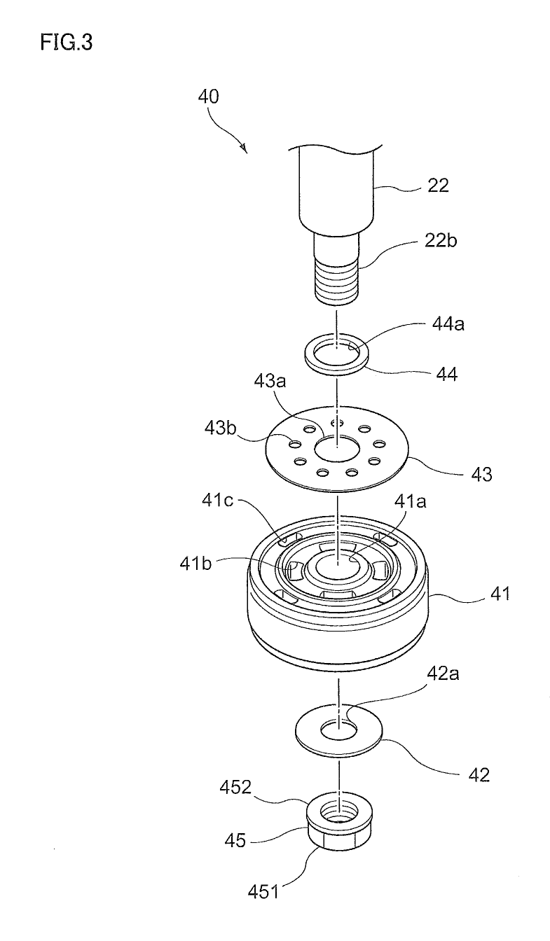

FIG. 3 is an exploded diagram for illustrating component parts of the second valve device 40.

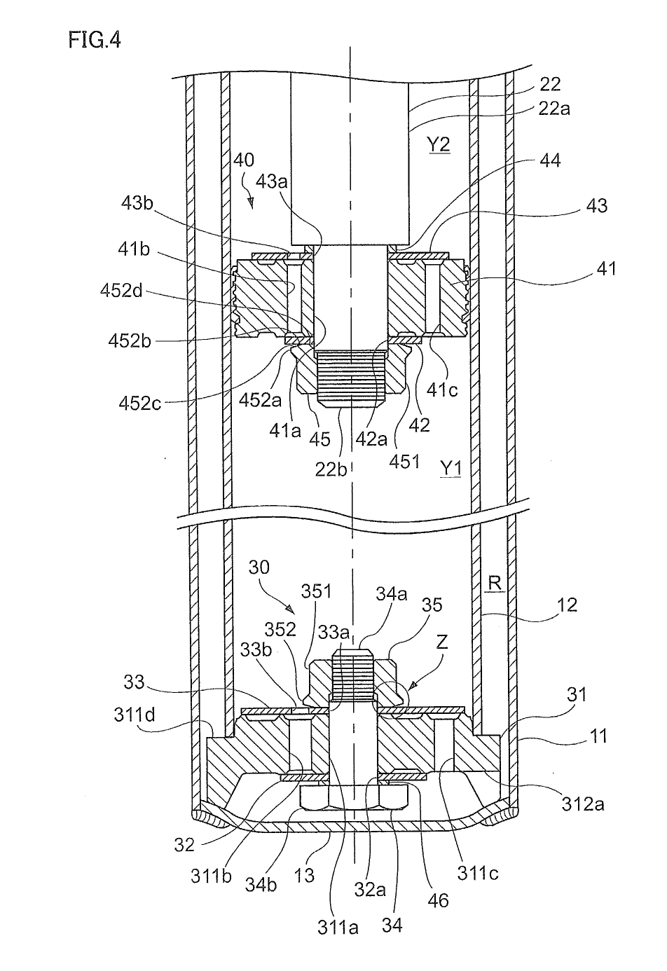

FIG. 4 is a cross sectional view of the first valve device 30 and the second valve device 40.

The first valve device 30 is provided with: the valve body 31 that has plural oil passages formed in the centerline direction; a first valve 32 that blocks one ends of some of the plural oil passages formed in the valve body 31 in the centerline direction; and a second valve 33 that blocks the other ends of some of the plural oil passages formed in the valve body 31 in the centerline direction. Further, the first valve device 30 is provided with a bolt 34 and a nut 35 for unitizing the valve body 31, the first valve 32, the second valve 33 and the like as individual parts. Furthermore, the first valve device 30 is provided with a washer 36 arranged between the first valve 32 and a head 34b of the bolt 34 that will be described later.

The valve body 31 includes a disc-shaped part 311 that is formed into a disc and a cylindrical part 312 that extends in the centerline direction from an outermost part of the disc-shaped part 311 in the radial direction and that is formed as a cylinder, and divides a closed space in the cylinder 10. As described above, the valve body 31 functions as an example of a dividing member.

In the disc-shaped part 311, a bolt-hole 311a that is formed in the centerline direction for making an axial part 34a of the bolt 34 pass therethrough, first oil passages 311b that are formed in the centerline direction at parts outside the bolt-hole 311a in the radial direction, and second oil passages 311c that are formed in the centerline direction at parts outside the first oil passages 311b in the radial direction are formed. Plural first oil passages 311b and plural second oil passages 311c (four oil passages in the exemplary embodiment) are formed at regular intervals in the circumferential direction, and they function as an example of a communicating passage that makes the first oil field Y1 and the reservoir R communicate with each other. However, when they are seen from the center in the radial direction, the first oil passages 311b and the second oil passages 311c are not formed in the same direction, and formed at relatively displaced positions in the circumferential direction. Open ends of the first oil passages 311b and the second oil passages 311c are formed at positions lower than the end face of the disc-shaped part 311 in the centerline direction. In other words, one end of the disc-shaped part 311 in the centerline direction has ring-shaped concave regions where the first oil passages 311b and the second oil passages 311c are respectively formed. In addition, the other end of the disc-shaped part 311 in the centerline direction has ring-shaped concave regions where the first oil passages 311b and the second oil passages 311c are respectively formed.

The disc-shaped part 311 has a stepped part 311d at an outermost radius section of the other end in the centerline direction, which is more concave than the end face on the center side in the radial direction. This stepped part 311d is in contact with one end part of the inner cylinder 12 in the centerline direction, so that the position of the inner cylinder 12 in the centerline direction is set.

The disc-shaped part 312 has plural concave parts 312a (four concave parts in the exemplary embodiment) arranged at regular intervals in the circumferential direction. The concave parts 312a are concave from the end face and are located on one end side in the centerline direction. By providing the concave parts 312a, the inside of the cylindrical part 312 and the reservoir R communicate with each other.

The first valve 32 is a disc-shaped component in which a bolt-hole 32a for making the axial part 34a of the bolt 34 pass therethrough is formed. The outer diameter of the first valve 32 has a size that blocks the first oil passages 311b and opens the second oil passages 311c.

The second valve 33 is a disc-shaped component in which a bolt-hole 33a is formed for making the axial part 34a of the bolt 34 pass therethrough. The outer diameter of the second valve 33 has a size that blocks the second oil passages 311c. In the second valve 33, plural oil holes 33b (nine oil holes in the exemplary embodiment) arranged at regular intervals in the circumferential direction are formed at positions corresponding to the first oil passages 311b when they are seen from the center in the radial direction.

The bolt 34 includes: the axial part 34a having a spirally-grooved tip; and the head 34b that is formed into a hexagonal cylinder.

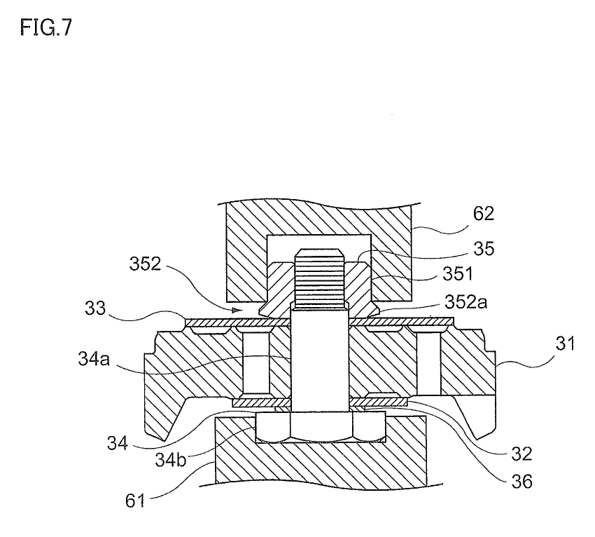

The nut 35 includes: a head 351 formed into a hexagonal cylinder that is fitted with an industrial tool; and a base end 352 that is arranged on the second valve 33 side beyond the head 351. A hole formed in the head 351 and the base end 352 in the centerline direction is spirally grooved, and thus a female screw is formed. The base end 352 has a flange 352a (refer to FIG. 7) that has a radius forming the outer shape thereof larger than the helical shape as an outer shape of the head 351. The flange 352a is an example of an extending part that extends outside the outer shape of the head 351 in the radial direction. The shape of the base end 352 of the nut 35 will be described later.

The washer 36 is a disc-shaped component in which a bolt-hole 36a for making the axial part 34a of the bolt 34 pass therethrough is formed. By arranging the washer 36 between the head 34b of the bolt 34 and the first valve 32, a space having the thickness of the washer 36 is formed between the head 34b of the bolt 34 and the first valve 32.

The second valve device 40 is provided with: the aforementioned piston 41; a first valve 42 that blocks one ends of some of the plural oil passages formed in the piston 41 in the centerline direction; a second valve 43 that blocks the other ends of some of the plural oil passages formed in the piston 41 in the centerline direction; and a washer 44 that is arranged between the piston rod 22 and the second valve 43. Further, the second valve device 40 is provided with a nut 45 for unitizing, together with the attachment part 22b as an example of a first columnar part of the piston rod 22, the piston 41, the first valve 42, the second valve 43 and the washer 44 as individual parts.

In the piston 41, a bolt-hole 41a that is formed in the centerline direction for making the attachment part 22b of the piston rod 22 pass through, first oil passages 41b that are formed in the centerline direction at parts outside the bolt-hole 41a in the radial direction, and second oil passages 41c that are formed in the centerline direction at parts outside the first oil passages 41b in the radial direction are formed. Plural first oil passages 41b and plural second oil passages 41c (four oil passages in the exemplary embodiment) are formed at regular intervals in the circumferential direction, and they function as an example of a communicating passage that makes the first oil field Y1 and the second oil field Y2 communicate with each other. However, when they are seen from the center in the radial direction, the first oil passages 41b and the second oil passages 41c are not formed in the same direction, and formed at relatively displaced positions in the circumferential direction. Open ends of the first oil passages 41b and the second oil passages 41c are formed at positions lower than the end face in the centerline direction. In other words, one end of the piston 41 in the centerline direction has ring-shaped concave regions where the first oil passages 41b and the second oil passages 41c are respectively formed. In addition, the other end of the piston 41 in the centerline direction has ring-shaped concave regions where the first oil passages 41b and the second oil passages 41c are respectively formed.

The first valve 42 is a disc-shaped component in which a bolt-hole 42a for making the attachment part 22b of the piston rod 22 pass therethrough is formed. The outer diameter of the first valve 42 has a size that blocks the first oil passages 41b and opens the second oil passages 41c.

The second valve 43 is a disc-shaped component in which a bolt-hole 43a is formed for making the attachment part 22b of the piston rod 22 pass therethrough. The outer diameter of the second valve 43 has a size that blocks the second oil passages 41c. In the second valve 43, plural oil holes 43b (nine oil holes in the exemplary embodiment) arranged at regular intervals in the circumferential direction are formed at positions corresponding to the first oil passages 41b when they are seen from the center in the radial direction.

A washer 44 is a disc-shaped component in which a bolt-hole 44a for making the attachment part 22b of the piston rod 22 pass therethrough is formed. By arranging the washer 44 between the attachment part 22b of the piston rod 22 and the second valve 43, a space having the thickness of the washer 44 is formed between the piston rod 22 and the second valve 43.

A nut 45 includes: a head 451 formed into a hexagonal cylinder that is fitted with an industrial tool; and a base end 452 that is arranged on the first valve 42 side beyond the head 451. A hole formed in the head 451 and the base end 452 in the centerline direction is spirally grooved, and thus a female screw is formed. The base end 452 has a flange 452a that has a radius forming the outer shape thereof larger than the helical shape as an outer shape of the head 451. The flange 452a is an example of an extending part that extends outside the outer shape of the head 451 in the radial direction. The shape of the base end 452 of the nut 45 will be described later.

Next, description will be given for behavior of the hydraulic shock absorber 100 having the aforementioned configuration.

First, description will be given for behavior of the hydraulic shock absorber 100 at a compression process.

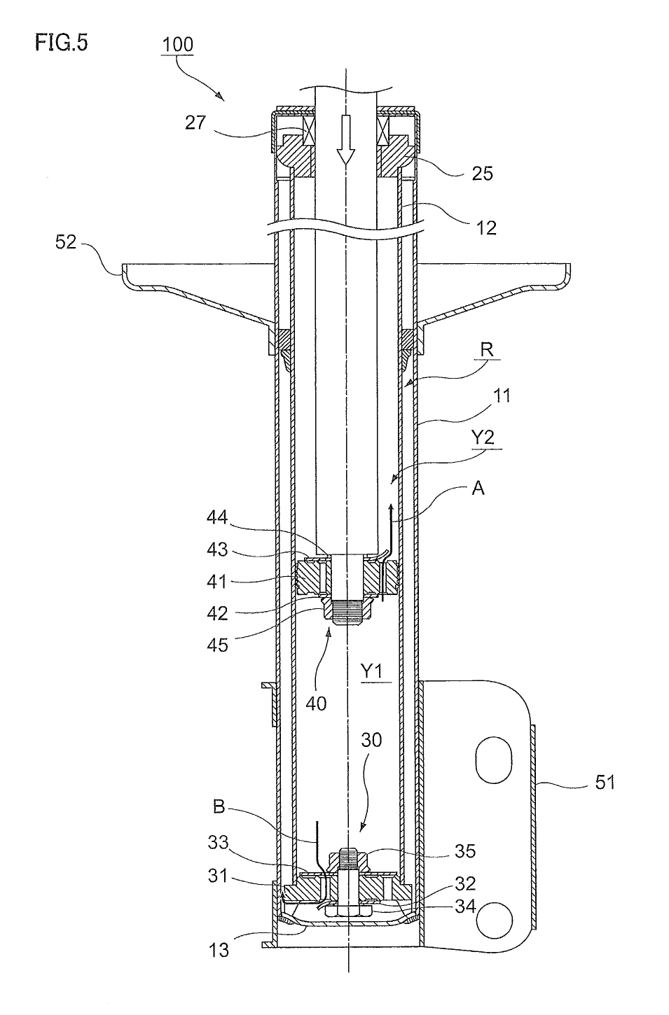

FIG. 5 is a view for illustrating flow of oil in the hydraulic shock absorber 100 at the compression process.

When the piston rod 22 moves toward one end side in the centerline direction with respect to the cylinder 10 (downward in FIG. 5) as shown by an outline arrow, oil inside the first oil field Y1 is pushed by the movement of the piston 41, pressure at the lower surface of the second valve device 40 is increased, and the second oil passages 41c (refer to FIG. 3) of the second valve device 40 is subjected to high pressure. As a result, the second valve 43 blocking the second oil passages 41c opens, and oil flows into the second oil field Y2 above the second valve device 40 via the second oil passages 41c as shown by an arrow A in FIG. 5. The flow of oil from the first oil field Y1 to the second oil field Y2 is restricted by the second valve 43 and the second oil passages 41c, and thereby damping force of the hydraulic shock absorber 100 at the compression process is obtained. As described above, damping force on the compression side is generated at the second valve 43 and the second oil passages 41c of the second valve device 40, and the damping force on the compression side is set by the rigidity of the second valve 43, the diameter of the second oil passages 41c and the like.

The pressure of the first oil field Y1, which has been increased by the movement of the piston rod 22 toward one end in the centerline direction, acts on the first oil passages 311b of the first valve device 30, and opens the first valve 32 that blocks the first oil passages 311b. Then, the oil inside the first oil field Y1 flows into the reservoir R formed between the inner cylinder 12 and the outer cylinder 11 via the first oil passages 311b and the concave parts 312a of the valve body 31, as shown by an arrow B in FIG. 5. The flow of oil from the first oil field Y1 to the reservoir R is restricted by the first valve 32 and the first oil passages 311b, and thereby damping force of the hydraulic shock absorber 100 at the compression process is obtained. As described above, damping force on the compression side is generated at the first valve 32 and the first oil passages 311b of the first valve device 30, and the damping force on the compression side is set by the rigidity of the first valve 32, the diameter of the first oil passages 311b and the like.

Next, description will be given for behavior of the hydraulic shock absorber 100 at an extension process.

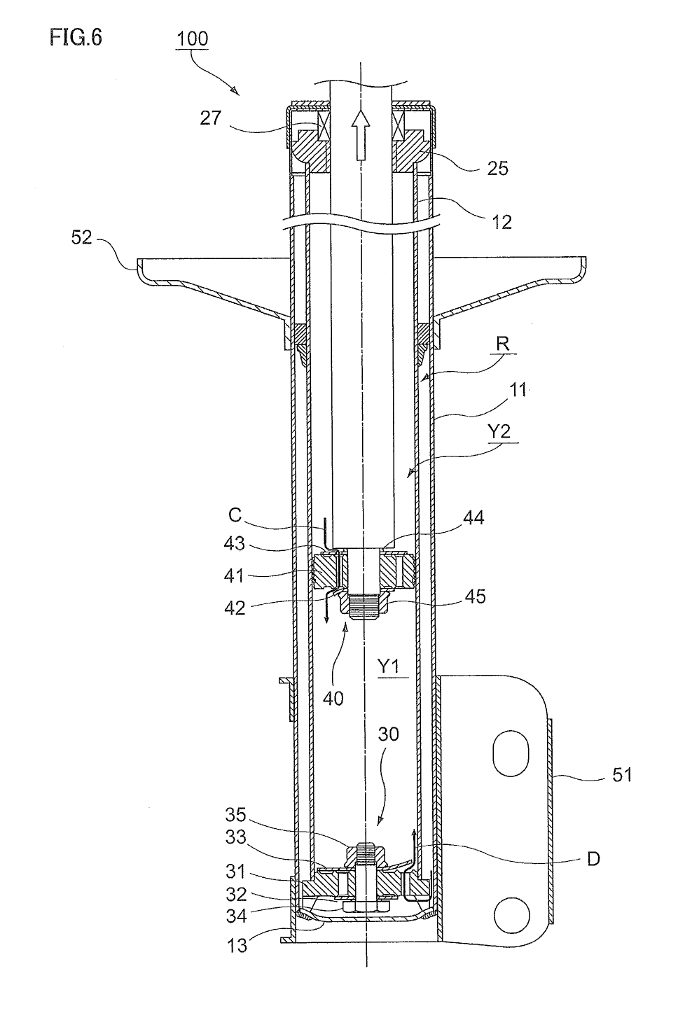

FIG. 6 is a view for illustrating flow of oil in the hydraulic shock absorber 100 at the extension process.

When the piston rod 22 moves toward the other end side in the centerline direction with respect to the cylinder 10 (upward in FIG. 6) as shown by an outline arrow, negative pressure is generated since volume of oil inside the first oil field Y1 equal to the volume of the movement is insufficient by the movement. Consequently, oil inside the second oil field Y2 passes through the first oil passages 41b of the second valve device 40, the first valve 42 blocking the first oil passages 41b is opened, and the oil flows into the first oil field Y1, as shown by an arrow C in FIG. 6. The flow of oil from the second oil field Y2 to the first oil field Y1 is restricted by the first valve 42 and the first oil passages 41b of the second valve device 40, and damping force of the hydraulic shock absorber 100 at the extension process is obtained. As described above, damping force on the extension side is generated at the first valve 42 and the first oil passages 41b of the second valve device 40, and the damping force on the extension side is set by the rigidity of the first valve 42, the diameter of the first oil passages 41b, and the like.

In addition, when the piston rod 22 moves in the direction of the outline arrow in FIG. 6, oil inside the reservoir R passes through the concave parts 312a and the second oil passages 311c of the valve body 31 of the first valve device 30, the second valve 33 blocking the second oil passages 311c is opened, and the oil flows into the first oil field Y1, as shown by an arrow D in FIG. 6. The flow of oil from the reservoir R to the first oil field Y1 is restricted by the second valve 33 and the second oil passages 311c of the first valve device 30, and damping force of the hydraulic shock absorber 100 at the extension process is obtained. As described above, damping force on the extension side is generated at the second valve 33 and the second oil passages 311c of the first valve device 30, and the damping force on the extension side is set by the rigidity of the second valve 33 of the first valve device 30, the diameter of the second oil passages 311c and the like.

Next, detailed description will be given for the shape of the nut 35 of the first valve device 30 in the hydraulic shock absorber 100 having the above-described configuration and behavior.

Before attaching the first valve device 30 to the hydraulic shock absorber 100, the first valve device 30 is unitized, and the unitized first valve device 30 is inserted into the outer cylinder 11 so as to be in contact with the bottom cap 13. Then, the inner cylinder 12 is inserted into the outer cylinder 11 so as to be in contact with the first valve device 30.

The nut 35 of the first valve device 30 has a function for unitizing the valve body 31, the first valve 32, the second valve 33 and the washer 36, together with the bolt 34.

FIG. 7 is a view for illustrating an appearance when the first valve device 30 is unitized.

For unitizing the first valve device 30, as shown in FIG. 7, the washer 36, the first valve 32, the valve body 31 and the second valve 33 are made to put on the axial part 34a of the bolt 34 in a state where the head 34b of the bolt 34 is fixed with a stationary tool 61 so as not to rotate. Then, they are fastened with the nut 35. At this time, the nut 35 is fitted with a tip of a tool for rotation 62, and is made to be rotated by rotating the tool for rotation 62, and then tightening force is increased.

In the nut 35 according to the exemplary embodiment, the outer diameter of the flange part 352a of the base end 352 is set as a size enough to make the tool for rotation 62 bump into the flange part 352a when the nut 35 is rotated with the tool for rotation 62 so that the tool for rotation 62 is inhibited from coming into contact with the second valve 33. By this configuration, in the first valve device 30 according to the exemplary embodiment, deformation of the second valve 33 due to the contact of the tool for rotation 62 with the second valve 33 when the first valve device 30 is unitized is suppressed. As a result, unstable damping force due to deformation of the second valve 33 is suppressed.

Here, instead of providing the nut 35 with the flange part 352a, for example, a disc-shaped component having a diameter not less than the diameter of the flange part 352a may be interposed between the nut 35 and the second valve 33 in order to prevent the tool for rotation 62 from coming into contact with the second valve 33 at fastening with the nut 35. However, by providing the nut 35 with the flange part 352a like the nut 35 according to the exemplary embodiment, it is possible to reduce the number of components and facilitate assembly of the first valve device 30. In addition, by using the nut 35 having the flange part 352a, it is possible to suppress misplacement of up-and-down of the nut, which possibly occurs in a case where the nut without the flange part 352a is used.

The shape of a part facing the second valve 33 in the nut 35 according to the exemplary embodiment is formed as described below.

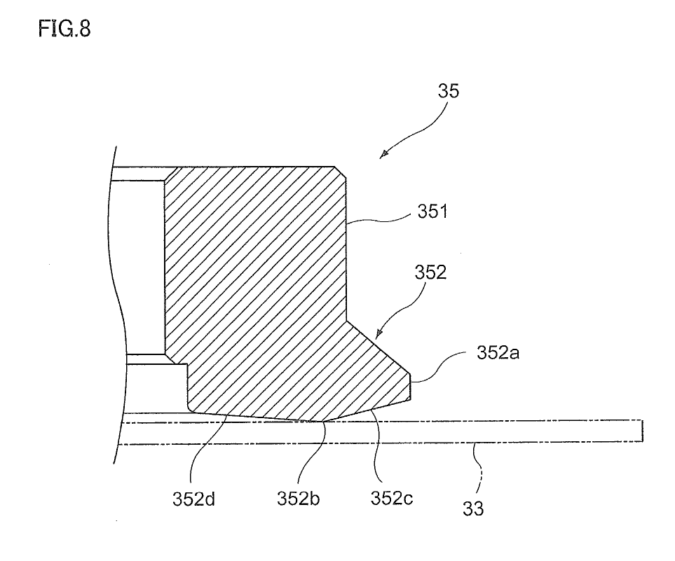

FIG. 8 is an enlarged cross-sectional view of the nut 35 in the first valve device 30, and is a view in which a Z part in FIG. 4 is enlarged.

As shown in FIG. 8, the part facing the second valve 33 in the base end 352 of the nut 35 is formed into a convex shape so that a part 352b (hereinbelow, which may be referred to as a “convex part 352b” in some cases) which has a radius smaller than the maximum radius of a part forming the side face of the flange part 352a is located at the nearest position from the second valve 33 side (the lower side in FIG. 8). Specifically, an outer part 352c, which is a part located outside with respect to the convex part 352b in the radial direction, is formed so as to have an inclined surface having a sharp angle (for example, 15 degrees) with respect to the horizontal surface. In addition, an inner part 352d, which is a part located inside with respect to the convex part 352b in the radial direction, is formed so as to have an inclined surface having a sharp angle (for example, 5 degrees) with respect to the horizontal surface. A curved line (circle) where the inclined surface of the outer part 352c and the inclined surface of the inner part 352d intersect with each other is the convex part 352b. However, the part where the inclined surface of the outer part 352c and the inclined surface of the inner part 352d intersect with each other may be processed so as to have the same curvature in all regions in the circumferential direction, and the nearest part from the second valve 33 side (the lower side in FIG. 8) in the processed region may be set as the convex part 352b. The convex part 352b functions as an example of a contact part which comes into contact with the second valve 33.

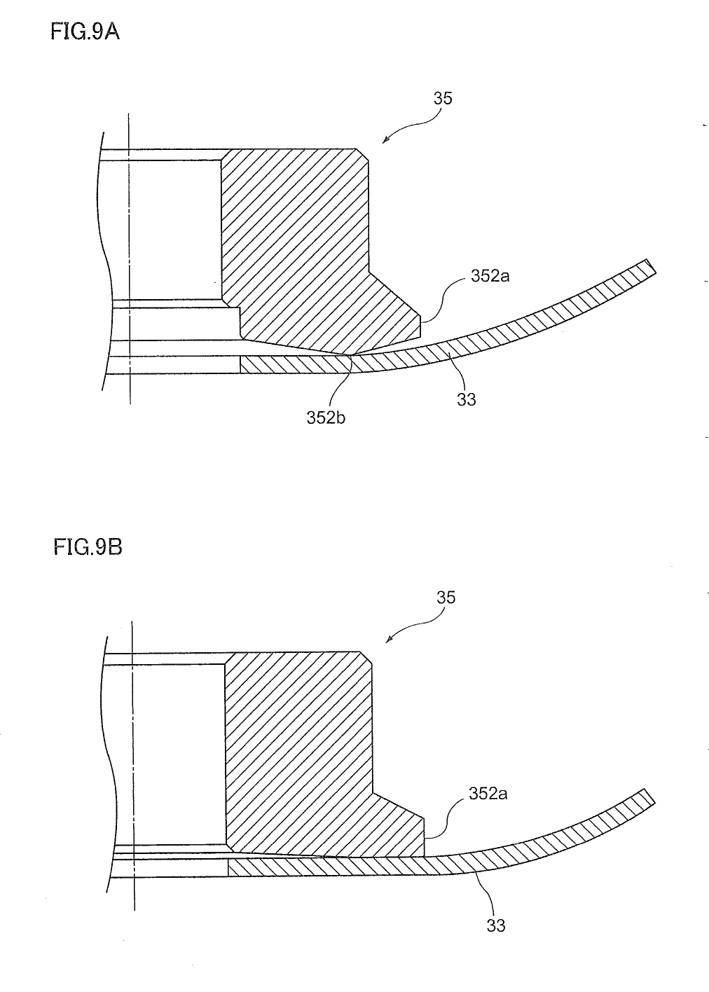

FIGS. 9A and 9B are views for schematically illustrating deformation of the second valve 33 at the extension process of the hydraulic shock absorber 100.

In the first valve device 30 including the nut 35 having the aforementioned configuration, at the extension process of the hydraulic shock absorber 100, the second valve 33 curves from a part which is in contact with the convex part 352b of the nut 35 due to the extending behavior of the piston rod 22, as shown in FIG. 9A.

Here, as a comparative configuration, the shape of the nut 35 on the side facing the second valve 33 is formed so that the part of the flange part 352a of the base end 352 having the maximum radius is located at the nearest position from the second valve 33 side (the lower side in FIG. 9). In a case where the nut 35 is formed by this comparative configuration, at the extension process of the hydraulic shock absorber 100, the second valve 33 curves from a part which is in contact with the part of the flange part 352a of the nut 35 having the maximum radius, as shown in FIG. 9B. That is, in the case where the nut 35 is formed by this comparative configuration, the position where the curve of the second valve 33 starts is located outside in comparison with the case where the nut 35 according to the exemplary embodiment is used. In other words, in the case where the nut 35 according to the exemplary embodiment is used, the position where the curve of the second valve 33 starts is located inside in comparison with the case of the comparative configuration.

As a result, in the first valve device 30, by using the nut 35 according to the exemplary embodiment, the second valve 33 is easily deformed in comparison with the case where the nut according to the comparative configuration is used, and thereby flow of oil from the reservoir R to the first oil field Y1 is smoother at the extension process of the hydraulic shock absorber 100. By this configuration, it is possible to suppress unstable damping force and reduction in responsiveness of the hydraulic shock absorber 100 due to lack of the amount of oil flowing from the reservoir R to the first oil field Y1 at the extension process.

As described above, in the first valve device 30 according to the exemplary embodiment, by forming the nut 35 into the shape according to the exemplary embodiment, it is possible to suppress deformation of the second valve 33 at the unitization, and unstable damping force and reduction in responsiveness at the extension process, while the number of components of the first valve device 30 is reduced and assembly thereof is facilitated.

Next, detailed description will be given for the shape of the nut 45 in the second valve device 40.

Similarly to the first valve device 30, the second valve device 40 is unitized before attached to the hydraulic shock absorber 100, and the unitized second valve device 40 is inserted into the inner cylinder 12.

The nut 45 of the second valve device 40 has a function for unitizing the piston 41, the first valve 42, the second valve 43 and the washer 44, together with the attachment part 22b of the piston rod 22.

For unitizing the second valve device 40, as described in the unitization of the first valve device 30 with FIG. 7, the washer 44, the second valve 43, the piston 41 and the first valve 42 are made to put on the attachment part 22b in a state where the attachment part 22b of the piston rod 22 is fixed with a stationary tool so as not to rotate. Then, they are fastened with the nut 45. At this time, the nut 45 is fitted with the tool for rotation 62, and is made to be rotated by rotating the tool for rotation 62, and then tightening force is increased.

In the nut 45 according to the exemplary embodiment, the outer diameter of the flange part 452a of the base end 452 is set as a size enough to make the tool for rotation 62 bump into the flange part 452a when the nut 45 is rotated with the tool for rotation 62 so that the tool for rotation 62 is inhibited from coming into contact with the first valve 42. By this configuration, in the second valve device 40 according to the exemplary embodiment, deformation of the first valve 42 due to the contact of the tool for rotation 62 with the first valve 42 when the second valve device 40 is unitized is suppressed. As a result, unstable damping force due to deformation of the first valve 42 is suppressed. By providing the nut 45 with the flange part 452a, it is possible to reduce the number of components and facilitate assembly of the second valve device 40 in comparison with a configuration in which the flange part 452a is not provided and for example, a disc-shaped component having a diameter not less than the diameter of the flange part 452a is interposed between the nut 45 and the first valve 42. In addition, it is possible to suppress misplacement of the nut 45.

A part facing the first valve 42 in the nut 45 of the second valve device 40 may have the same shape as the aforementioned nut 35 of the first valve device 30.

That is, the part facing the first valve 42 in the nut 45 is formed into a convex shape so that a part 452b (hereinbelow, which may be referred to as a “convex part 452b” in some cases) which has a radius smaller than the maximum radius of a part forming the side face of the flange part 452a of the base end 452 (refer to FIG. 4) is located at the nearest position from the first valve 42 side. Specifically, an outer part 452c, which is a part located outside with respect to the convex part 452b in the radial direction, is formed so as to have an inclined surface having a sharp angle (for example, 15 degrees) with respect to the horizontal surface. In addition, an inner part 452d, which is a part located inside with respect to the convex part 452b in the radial direction, is formed so as to have an inclined surface having a sharp angle (for example, 5 degrees) with respect to the horizontal surface. Note that, a curved line (circle) where the inclined surface of the outer part 452c and the inclined surface of the inner part 452d intersect with each other is the convex part 452b. However, the part where the inclined surface of the outer part 452c and the inclined surface of the inner part 452d intersect with each other may be processed so as to have the same curvature in all regions in the circumferential direction, and the nearest part from the first valve 42 side in the processed region may be set as the convex part 452b. The convex part 452b functions as an example of a contact part which comes into contact with the first valve 42.

In the second valve device 40 that includes the nut 45 having such a configuration, at the extension process of the hydraulic shock absorber 100, the first valve 42 curves from the part coming into contact with the convex part 452b of the nut 45 by pressure of oil which is increased by the extension behavior of the piston rod 22. As a result, the first valve 42 is easily deformed in comparison with a case where the nut in the aforementioned comparative configuration is used, and oil from the second oil field Y2 to the first oil field Y1 smoothly flows at the extension process of the hydraulic shock absorber 100. Thereby, it is possible to suppress unstable damping force and reduction in responsiveness of the hydraulic shock absorber 100 due to lack of the amount of oil flowing from the second oil field Y2 to the first oil field Y1 at the extension process.

As described above, in the second valve device 40 according to the exemplary embodiment, by forming the nut 45 into the shape according to the exemplary embodiment, it is possible to suppress deformation of the first valve 42 at the unitization, and unstable damping force and reduction in responsiveness at the extension process, while the number of components of the second valve device 40 is reduced and assembly thereof is facilitated.

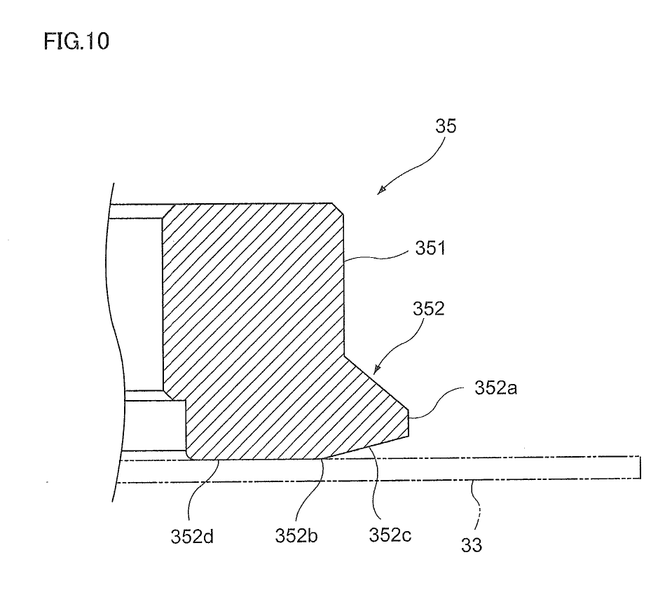

FIG. 10 is a view for illustrating another configuration of the nut 35 of the first valve device 30.

In the aforementioned exemplary embodiment, the inner part 352d, which is a part located inside with respect to the convex part 352b of the nut 35 of the first valve device 30 in the radial direction, is formed so as to have a shape angle with respect to the horizontal surface. However, it is not limited to the aforementioned shape. For example, as shown in FIG. 10, the inner part 352d may be a horizontal surface entirely coming into contact with the second valve 33. By this configuration, a contact region between the nut 35 and the second valve 33 is increased, and thereby it is possible to suppress stress generated in the second valve 33.

The same is true for the nut 45 of the second valve device 40, and thus the inner part 452d may be a horizontal surface entirely coming into contact with the first valve 42. By this configuration, a contact region between the nut 45 and the first valve 42 is increased, and thereby it is possible to suppress stress generated in the first valve 42.

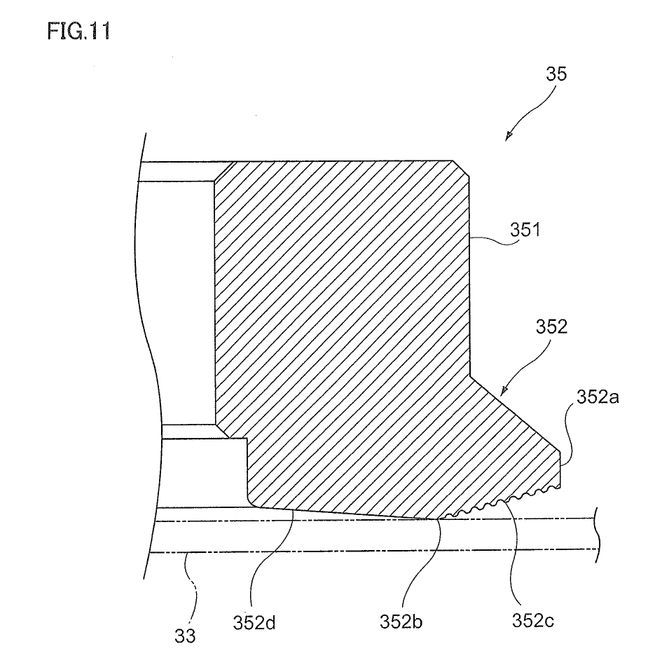

FIG. 11 is a view for illustrating further configuration of the nut 35 of the first valve device 30.

The outer part 352c of the nut 35 in the first valve device 30 is an inclined surface inclined with respect to the horizontal surface, and the inclined surface may be a concave-convex surface, as shown in FIG. 11. By this configuration, when the second valve 33 curves at the extension process of the hydraulic shock absorber 100, the contact area with the second valve 33 is decreased. Thereby, it is possible to suppress unstable damping force of the hydraulic shock absorber 100 due to adhesion of the second valve 33 to the outer part 352c.

The same is true for the nut 45 of the second valve device 40, and the outer part 452c as an inclined surface may be a concave-convex surface. By this configuration, when the first valve 42 curves at the extension process of the hydraulic shock absorber 100, the contact area with the first valve 42 is decreased. Thereby, it is possible to suppress unstable damping force of the hydraulic shock absorber 100 due to adhesion of the first valve 42 to the outer part 452c.

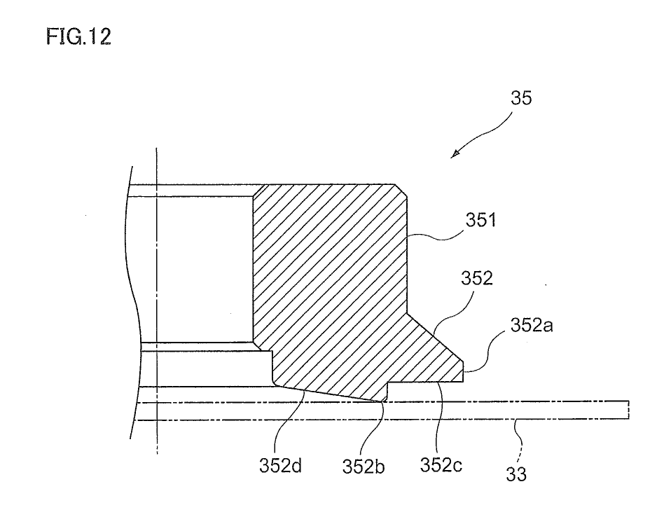

FIG. 12 is a view for illustrating furthermore configuration of the nut 35 of the first valve device 30.

The outer part 352c of the nut 35 of the first valve device 30 may not be an inclined surface inclined with respect to the horizontal surface.

It is only necessary for the outer part 352c of the nut 35 to have a configuration such that the second valve 33 curves from a point at the convex part 352b at the extension process of the hydraulic shock absorber 100, and it may be a horizontal surface formed on the other end side beyond the convex part 352b in the centerline direction, as shown in FIG. 12.

The same is true for the nut 45 of the second valve device 40, and the outer part 452c of the nut 45 may be a horizontal surface formed on the other end side beyond the convex part 452b in the centerline direction.

In the aforementioned exemplary embodiment, the outer diameter of the flange part 352a of the nut 35 of the first valve device 30 is set as a size enough to make the tool for rotation 62 bump into the flange part 352a when the nut 35 is rotated so that the tool for rotation 62 is inhibited from coming into contact with the second valve 33. However, another configuration described below may be accepted.

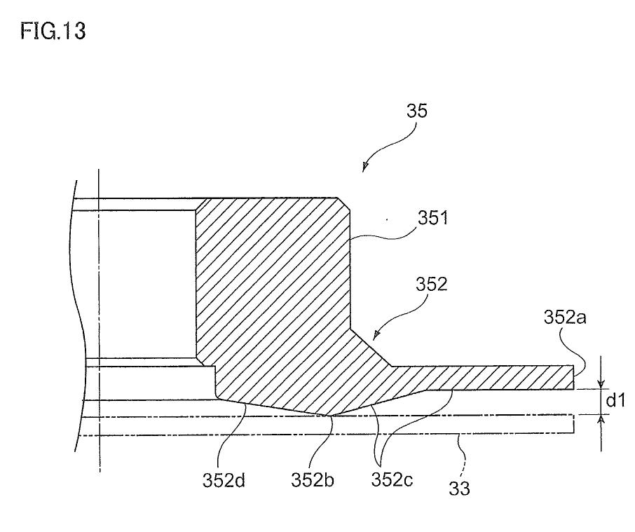

FIG. 13 is a view for illustrating still furthermore configuration of the nut 35 of the first valve device 30.

As shown in FIG. 13, the outer diameter of the flange part 352a of the base end 352 is approximately the same as the outer diameter of the second valve 30, and the outer part 352c is formed of an inclined surface having a sharp angle (for example, 15 degrees) with respect to the horizontal surface, and a horizontal surface displaced on the other end side in the centerline direction by a predetermined distance d1 with respect to the horizontal surface passing through the convex part 352b.

In a case where the nut 35 has such a shape, when the second valve 33 curves from a point at the convex part 352b at the extension process of the hydraulic shock absorber 100, the outermost diameter part of the second valve 33 bumps into the outer part 352c of the base end 352, and further deformation is suppressed. In other words, the amount of deformation of the second valve 33 at the extension process of the hydraulic shock absorber 100 is adjustable. Hence, by using the first valve device 30 having the nut 35 shown in FIG. 13, the dumping force at the extension process of the hydraulic shock absorber 100 is more precisely adjustable. Note that, the distance d1 between the horizontal surface of the outer part 352c and the horizontal surface passing through the convex part 352b may be set on the basis of the damping force required at the extension process of the hydraulic shock absorber 100. In addition, it is only necessary for the flange part 352a to have an outer diameter enough to make the outermost diameter part of the second valve 33 bump into the outer part 352c of the base end 352 when the second valve 33 curves.

The same is true for the nut 45 of the second valve device 40, and, in the nut 45, the outer diameter of the flange part 452a of the base end 452 is approximately the same as the outer diameter of the first valve 42, and the outer part 452c may be formed of an inclined surface having a sharp angle with respect to the horizontal surface, and a horizontal surface displaced on the other end side in the centerline direction by a distance d2 with respect to the horizontal surface passing through the convex part 452b.

In a case where the nut 45 has such a configuration, when the first valve 42 curves from a point at the convex part 452b at the extension process of the hydraulic shock absorber 100, the outermost diameter part of the first valve 42 bumps into the outer part 452c of the base end 452, and further deformation is suppressed. In other words, the amount of deformation of the first valve 42 at the extension process of the hydraulic shock absorber 100 is adjustable. Hence, the dumping force at the extension process of the hydraulic shock absorber 100 is more precisely adjustable. Note that, the distance d2 between the horizontal surface of the outer part 452c and the horizontal surface passing through the convex part 452b may be set on the basis of the damping force required at the compression process of the hydraulic shock absorber 100. In addition, it is only necessary for the flange part 452a to have an outer diameter enough to make the outermost diameter part of the first valve 42 bump into the outer part 452c of the base end 452 when the first valve 42 curves.

In the aforementioned exemplary embodiment, description has been given for the base end 352 of the nut 35 of the first valve device 30 and the base end 452 of the nut 45 of the second valve device 40 mainly. However, in the bolt 34 of the first valve device 30, a part having the same shape as the base end 352 may be provided. In addition, the part of the piston rod 22, which faces the second valve 43, may be formed into the same shape as the part of the base end 452, which faces the first valve 42.

That is, the bolt 34 of the first valve device 30 is formed of the axial part 34a, the head 34b that is fitted with an industrial tool, and a base end of the bolt (not shown) having the same shape as the aforementioned base end 352. Further, the washer 36 is removed, and the first valve 32 and the like are fastened so that the base end of the bolt comes into contact with the first valve 32. By this configuration, tightening force is increased by rotating the bolt 34 with the tool for rotation 62, and even if the first valve device 30 is unitized, deformation of the first valve 32 due to contact of the tool for rotation 62 with the first valve 32 is suppressed, and unstable damping force is also suppressed. In addition, it is possible to suppress unstable damping force and reduction in responsiveness at the compression process, while the number of components is reduced and assembly is facilitated by removing the washer 36.

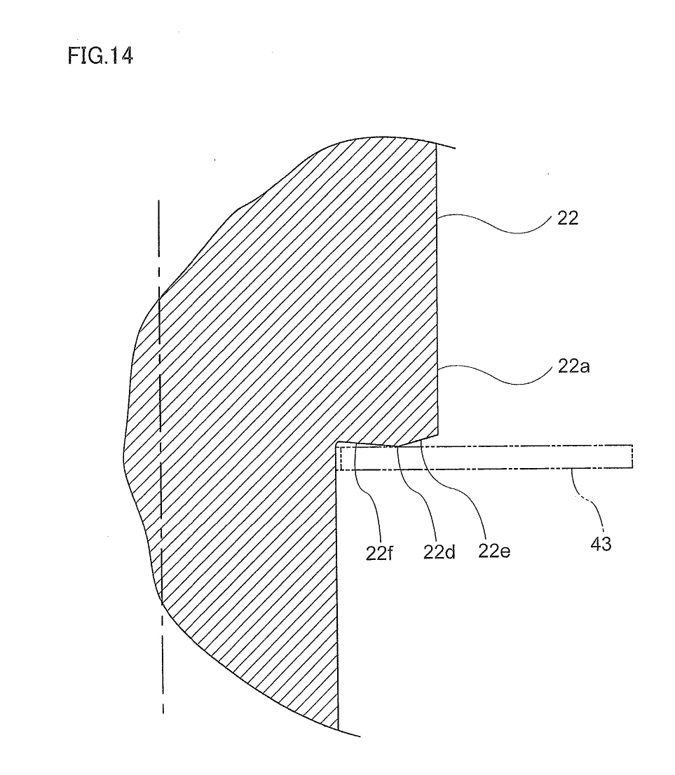

FIG. 14 is a view for illustrating another configuration of the second valve device 40.

As shown in FIG. 14, a part facing the second valve 43, which is one end part of the rod part 22a in the centerline direction, as an example of a second columnar part of the piston rod 22, is formed into a convex shape so that a part 22d (hereinafter, referred to as “a convex part 22d” in some cases) having a radius smaller than the maximum radius of a part forming the outer circumferential surface of the rod part 22a is located at the nearest position from the second valve 43 side. Specifically, as shown in FIG. 14, an outer part 22e that is a part located outside the convex part 22d in the radial direction is formed as an inclined surface having a sharp angle (for example, 15 degrees) with respect to the horizontal surface. An inner part 22f that is a part located inside the convex part 22d in the radial direction is formed as an inclined surface having a sharp angle (for example, 5 degrees) with respect to the horizontal surface. The washer 44 is removed, and the second valve 43, the piston 41 and the first valve 42 are fastened with the attachment part 22b of the piston rod 22 and the nut 45 so that one end of the rod part 22a of the piston rod 22 in the centerline direction comes into contact with the second valve 43. That is, the washer 44 is removed so that the convex part 22d of the piston rod 22 functions as an example of a contact part that comes into contact with the second valve 43. Hence, it is possible to suppress unstable damping force and reduction in responsiveness at the compression process, while the number of components is reduced and assembly is facilitated by removing the washer 44.

Note that, the curved line (circle) where the inclined surface of the outer part 22e and the inclined surface of the inner part 22f intersect with each other is the convex part 22d. However, the part where the inclined surface of the outer part 22e and the inclined surface of the inner part 22f intersect with each other may be processed so as to have the same curvature in all regions in the circumferential direction, and the nearest part from the second valve 43 side (lower side in FIG. 14) in the processed region may be set as the convex part 22d.

Alternatively, a whole surface of the inner part 22f of one end in the centerline direction of the rod part 22a of the piston rod 22 may be a horizontal surface coming into contact with the second valve 43. By this configuration, a contact region between the rod part 22a and the second valve 43 is increased, and thereby it is possible to suppress stress generated at the second valve 43.

Concavities and convexities may be provided on the front surface of the outer part 22e as the inclined surface of the rod part 22a of the piston rod 22. By this configuration, when the second valve 43 curves at the compression process of the hydraulic shock absorber 100, the contact area with the second valve 43 is decreased, and hence it is possible to suppress unstable damping force of the hydraulic shock absorber 100 due to adhesion of the second valve 43 to the outer part 22e. Note that, as described above, the outer part 22e may be a horizontal surface formed on the other end side beyond the convex part 22d in the centerline direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A hydraulic shock absorber comprising:
a dividing member that divides a closed space and in which a communicating passage for communicating divided spaces is formed;
a valve that covers an open end of the communicating passage of the dividing member;
a bolt that penetrates through the dividing member and the valve; and
a nut that fastens the dividing member and the valve together with the bolt, wherein
the bolt or the nut has a head that is fitted with an industrial tool, and a base end that is arranged on a valve side beyond the head to come into contact with the valve and includes an extending part extending outside an outer shape of the head in a radial direction, a facing part of the base end that faces the valve comes into contact with the valve at a position inside an outermost end of the extending part in the radial direction, and an outer region outside a contact part does not come into contact with the valve.

2. The hydraulic shock absorber according to claim 1, wherein
the outer region of the base end outside the contact part coming into contact with the valve is inclined with respect to a horizontal surface passing through the contact part.

3. The hydraulic shock absorber according to claim 1, wherein
the outer region of the base end outside the contact part coming into contact with the valve is an inclined surface that is inclined with respect to a horizontal surface passing through the contact part, and the inclined surface is a concave-convex surface.

4. The hydraulic shock absorber according to claim 1, wherein
the facing part of the base end facing the valve comes into contact with an outermost end of the valve when the valve deforms from the contact part with the base end.

5. The hydraulic shock absorber according to claim 1, wherein
the base end and the valve come into surface contact with each other.

6. A hydraulic shock absorber comprising:
a dividing member that divides a closed space and in which a communicating passage for communicating divided spaces is formed;
a valve that covers an open end of the communicating passage of the dividing member;
a rod that has a first columnar part that is formed into a column and that penetrates through the dividing member and the valve, and a second columnar part that is formed into a column and that has an outer diameter larger than an outer diameter of the first columnar part; and
a nut that fastens the dividing member and the valve together with a male screw formed in the first columnar part of the rod, wherein
a facing part of the second columnar part of the rod that faces the valve comes into contact with the valve at a position inside an outer circumferential surface of the second columnar part, and an outer region outside a contact part does not come into contact with the valve.

7. A damping force generator of a hydraulic shock absorber in which oil is enclosed in a closed space, the damping force generator comprising:
a dividing member that divides the closed space and in which a communicating passage for communicating divided spaces is formed;
a valve that covers an open end of the communicating passage of the dividing member;
a bolt that penetrates through the dividing member and the valve; and
a nut that fastens the dividing member and the valve together with the bolt, wherein
the bolt or the nut has a head that is fitted with an industrial tool, and a base end that is arranged on a valve side beyond the head to come into contact with the valve and includes an extending part extending outside an outer shape of the head in a radial direction, the base end comes into contact with the valve at a position inside an outermost end of the extending part in the radial direction, and an outer region outside a contact part does not come into contact with the valve.

8. A damping force generator of a hydraulic shock absorber in which oil is enclosed in a closed space, the damping force generator comprising:
a dividing member that divides the closed space and in which a communicating passage for communicating divided spaces is formed;
a valve that covers an open end of the communicating passage of the dividing member;
a rod that has a first columnar part that is formed into a column and that penetrates through the dividing member and the valve, and a second columnar part that is formed into a column and that has an outer diameter larger than an outer diameter of the first columnar part; and
a nut that fastens the dividing member and the valve together with a male screw formed in the first columnar part of the rod, wherein
a facing part of the second columnar part of the rod that faces the valve comes into contact with the valve at a position inside an outer circumferential surface of the second columnar part, and an outer region outside a contact part does not come into contact with the valve.
